(19) United States
(12) Patent Application Publication
(10) Pub. No.: US 2020/0065881 A1
(43) Pub. Date: Feb. 27, 2020

(54) Retail Ordering System With Facial Recognition

(71) Applicant: Bite Inc., New York, NY (US)

(72) Inventors: Steve Truong, Toronto (CA); Jeff Hong, Toronto (CA); Stas Nikiforov, New York, NY (US); Brandon Barton, Brooklyn, NY (US)

(21) Appl. No.: 16/547,089

(22) Filed: Aug. 21, 2019

Related U.S. Application Data
(60) Provisional application No. 62/720,152, filed on Aug. 21, 2018.

(51) Int. Cl. G06Q 30/06; G06K 9/00; G06K 9/32; G06N 20/00; H04N 5/247

(52) U.S. Cl. CPC G06Q 30/0631; G06Q 30/0633; G06Q 30/0643; H04N 5/247; G06K 9/325; G06N 20/00; G06K 9/00288

(57) ABSTRACT

Disclosed herein is a network-based retail order satisfaction system, and related methods, having a local processor, a local kiosk having at least one camera and a digital display, a central processor, a customer information database, and facial recognition software configured to identify a returning customer. Disclosed herein is a network-based retail order satisfaction system, and related methods, having machine learning software configured to predict a returning customer's order and provide menu items on the digital display based on the predicted order.

### CROSS-REFERENCE TO RELATED APPLICATION(S)

This application claims the benefit under 35 U.S.C. § 119(e) to U.S. Provisional Application 62/720,152, filed Aug. 21, 2018 and entitled “Drive-Through System Utilizing Facial Recognition and Machine Learning,” which is hereby incorporated herein by reference in its entirety.

### FIELD

The various embodiments herein relate to customer ordering interfaces, including, for example, ordering kiosks. Further, certain implementations relate to drive-through kiosks of the type used by fast food restaurants.

### BACKGROUND

Known drive-through systems typically include a central communications interface manned by a staff member and a drive-through kiosk that displays the menu and allows for a customer to communicate with the staff member. Such systems do not store any data regarding previous guests or their order history or provide for any recall of such information.

There is a need in the art for improved drive-through systems.

### BRIEF SUMMARY

Discussed herein are various systems and methods for retail order satisfaction that include display of personalized menu items for the customer.

In Example 1, a network-based retail order satisfaction system comprises a local processor on a network, the local processor accessible by an employee user, a local kiosk, a central processor in communication with the local processor via the network, a customer information database in communication with the central processor, the customer information database configured to store customer information and existing customer images, and facial recognition software associated with the central processor, the facial recognition software configured to compare an image of an individual captured by the at least one camera with the existing customer images. The local kiosk comprises at least one camera disposed on or near the kiosk, wherein the at least one camera is operably coupled to the network, a digital display disposed on the kiosk, wherein the digital display is operably coupled to the network, a speaker disposed on the kiosk, and a microphone disposed on the kiosk.

Example 2 relates to the order satisfaction system according to Example 1, further comprising machine learning software associated with the central processor, the machine learning software configured to learn customer preferences and predict future customer preferences based on historical customer order information.

#3099203

Example 3 relates to the order satisfaction system according to Example 2, wherein the machine learning software is further configured to select menu items to display on the digital display based on the customer preferences.

Example 4 relates to the order satisfaction system according to Example 1, further comprising additional local kiosks, wherein each of the additional local kiosks is disposed at a different location.

Example 5 relates to the order satisfaction system according to Example 4, wherein the central processor is disposed at a remote location in relation to the local kiosk and the additional local kiosks.

Example 6 relates to the order satisfaction system according to Example 1, wherein the at least one camera comprises a first camera disposed to capture the image of the individual, and a second camera disposed to capture an image of a car lane adjacent to the kiosk.

Example 7 relates to the order satisfaction system according to Example 6, wherein the facial recognition software is configured to compare the image of the individual captured by the first camera with the existing customer images, and object recognition software is configured to analyze the image of the car lane and determine a number of cars disposed in the car lane.

Example 8 relates to the order satisfaction system according to Example 1, wherein the at least one camera comprises a first camera disposed to capture the image of the individual, and a third camera disposed to capture an image of a license plate on a car adjacent to the kiosk.

Example 9 relates to the order satisfaction system according to Example 8, wherein the facial recognition software is configured to compare the image of the individual captured by the first camera with the existing customer images, and object recognition software is configured to analyze the image of the license plate captured by the third camera and compare a number on the license plate with the customer information.

Example 10 relates to the order satisfaction system according to Example 1, wherein the system can be incorporated into an existing point-of-sale system and the local processor is coupled to an existing point-of-sale interface.

In Example 11, a network-based retail order satisfaction system comprises a local processor on a network, the local processor accessible by an employee user, a plurality of local kiosks, a central processor in communication with the local processor via the network, a customer information database in communication with the central processor, the customer information database configured to store customer information existing customer images, facial recognition software associated with the central processor, the facial recognition software configured to compare the image of the individual captured by the user image camera with the existing customer images, machine learning software associated with the central processor, the machine learning software configured to learn customer preferences and predict future customer preferences based on historical customer order information, and object recognition software. Each of the plurality of local kiosks comprises a user image camera disposed on or near the kiosk to capture an image of an individual, wherein the user image camera is operably coupled to the network, a digital display disposed on the kiosk, wherein the digital display is operably coupled to the network, a car lane camera disposed on or near the kiosk to capture an image of a car lane adjacent to the kiosk, wherein the car lane camera is operably coupled to the network, a license plate camera disposed on or near the kiosk to capture an image of a license plate on a car adjacent to the kiosk, wherein the license plate camera is operably coupled to the network, a speaker disposed on the kiosk, and a microphone disposed on the kiosk. The object recognition software is configured to analyze the image of the car lane and determine a number of cars disposed in the car lane, and analyze the image of the license plate captured by the third camera and compare a number on the license plate with the customer information.

Example 12 relates to the order satisfaction system according to Example 11, wherein the central processor is disposed at a different location in relation to the plurality of local kiosks.

Example 13 relates to the order satisfaction system according to Example 11, wherein the system can be incorporated into existing point-of-sale systems at a plurality of retail locations.

Example 14 relates to the order satisfaction system according to Example 13, wherein the local processer is coupled to an existing point-of-sale interface.

In Example 15, a method of receiving and fulfilling a retail order comprises providing a local kiosk at a retail location, capturing an image of a customer with the at least one camera, identifying the customer based on the image of the customer, using stored customer information about the customer to predict future customer preferences, and providing menu items for selection by a customer on the digital display based on the predicted future customer preferences. The kiosk comprises at least one camera disposed on or near the kiosk, a digital display disposed on the kiosk, a speaker disposed on the kiosk, and a microphone disposed on the kiosk;

Example 16 relates to the method according to Example 15, wherein the identifying the customer based on the image of the customer further comprises comparing the image of the customer with existing customer images from a customer information database.

Example 17 relates to the method according to Example 15, wherein the kiosk further comprises a first camera disposed to capture the image of the individual, and a second camera disposed to capture an image of a car lane adjacent to the kiosk.

Example 18 relates to the method according to Example 17, further comprising capturing the image of the customer with the first camera, capturing the image of the car lane with the second camera, and determining a number of cars disposed in the car lane based on the image of the car lane.

Example 19 relates to the method according to Example 15, wherein the kiosk further comprises a first camera disposed to capture an image of a license plate on a car adjacent to the kiosk, and a second camera disposed to capture an image of a car lane adjacent to the kiosk.

Example 20 relates to the method according to Example 19, further comprising capturing the image of the license plate with the first camera, identifying the customer based on the image of the license plate, capturing the image of the car lane with the second camera, and determining a number of cars disposed in the car lane based on the image of the car lane.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

FIG. 1 is a schematic view of a retail order-fulfillment system, according to one embodiment.

FIG. 2 is a schematic depiction of the various components of the retail order fulfillment system of FIG. 1, according to one embodiment.

FIG. 3 is a front view of an exemplary kiosk for a retail order fulfillment system, according to one embodiment.

### DETAILED DESCRIPTION

The various embodiments disclosed or contemplated herein relate to a retail ordering system, including, for example, a drive-through ordering system, having a remote database for storing customer information and a facial recognition system that can be used to identify a customer at the ordering kiosk and quickly access the relevant stored customer information relating to that customer. Using the stored information, the system can provide the employee with the customer's order history and other information about the customer so that the employee can utilize that information to better serve the customer. Further, the system can also use the stored information to provide personalized ordering, offers, and opportunities to the customer based on the stored information. In addition, the system can also identify a new customer and thereby allow the employee to provide better service for that new customer. Plus, as described in addition detail below, certain embodiments of the system, can be coupled to multiple kiosks across multiple, widespread locations such that a customer can use the kiosk at any branch of the same retail organization (such as a restaurant chain) at any location across a country or the world and the system will recognize the customer and tailor the ordering experience to that customer.

As discussed in additional detail below, various system embodiments can provide a number of features relating to personalized ordering from a digital menu. For example, in certain implementations depending on the configuration thereof, the system can provide for any one or more of the following features: automatically displaying a customer's order history to the customer and/or the employee, providing for functionality that allows for the customer to instantly reorder previous orders (and can allow the customer to further customize the reorder), tailoring new offers, including item upsells and special promotions to the customer based on the customer's past orders and user profile, maintaining a loyalty program for each customer (which can include, for example, discounts and free offers) that is instantly accessed when a customer is in the drive-through, improving the employee hospitality toward the guest based on the customer information available to the employee, and allowing for storage and easy use of the customer's preferred method of payment (such as retaining the customer's credit card information) and thereby improving payment speed.

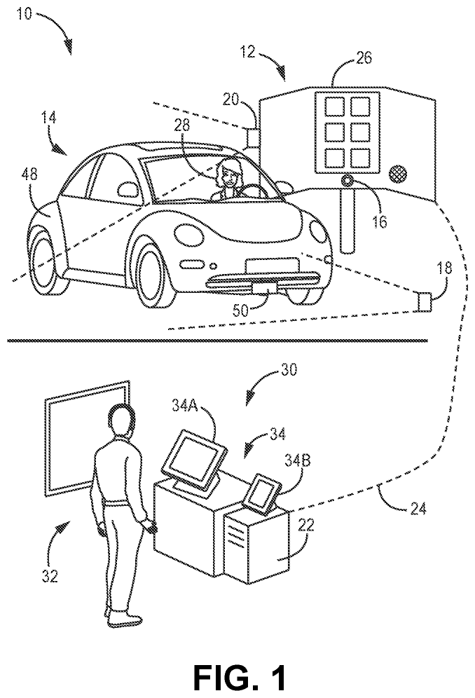

FIG. 1 depicts one exemplary embodiment of the drive-through system 10. At the outdoor drive-through kiosk 12 (disposed adjacent to the “drive-through lane” 14), the system 10 has one or more high resolution cameras and/or infrared cameras. According to one embodiment, at least one of the one or more cameras can be positioned on the existing menu board as shown. Alternatively, the one or more cameras can be positioned at any other location such that they capture a view into the vehicle and thus capture a clear, high-resolution image of the driver's face or the vehicle's license plate, as well as the overall line of individual vehicles entering the drive thru. As such, various implementations of the system herein can have at least three cameras, including a first camera (also referred to herein as a “user image camera”) 16 positioned to capture an image of the user (such as the driver in the car in the drive-through) 28, a second camera (also referred to herein as a “license plate camera”) 18 positioned to capture an image of the license plate of each car as it moves through the drive through or is stopped in front of the kiosk, and a third camera (also referred to herein as a “car lane camera”) 20 positioned to capture an image of the car lane such that it captures an image of all of the cars in line at the drive-through waiting for an opportunity to place an order at the kiosk. The three cameras 16, 18, 20 (or, according to various alternative embodiments, the at least one camera) are connected to a local processor (described in further detail below) 22, either via a wired electronic connection 24 as shown, or alternatively via a wireless connection. Further, in this implementation, the kiosk 12 has a kiosk menu board 26 that, in this specific embodiment, is a digital menu screen 26, which is also coupled to the local processor 22 via the electronic connection 24.

It is understood that the kiosk can have the standard configuration of known retail kiosks, including, for example, drive-through kiosks, except as described herein.

The system 10 also has a central console (or central station) 30 disposed within the restaurant (or other retail establishment) that is used by the employee 32. The console 30 includes the local processor 22 (which can be any known processor, including any known computer or server), which, as mentioned above, is coupled to the cameras 16, 18, 20 and the menu screen 26 via the electronic connection 24. Further, the console 30 has at least one interface 34 that can be used by the employee 32 to use the system. More specifically, in this specific embodiment as shown, the console 30 has two interfaces 34: the point-of-sale interface 34A and the touch screen interface 34B. Alternatively, the interface 34 can be any known interface 34, such as a computer tablet or keyboard and screen. It is understood that the processor 22 and interface 34 can be one known device (such as a known computer with a keyboard and screen or a tablet) or two or more separate known devices as shown.

It is understood that the system embodiments disclosed or contemplated herein, including the system 10 depicted in FIG. 1 and described above, can be a new system that is constructed or built from entirely new components, or it can be integrated into an existing system by adding the necessary new hardware thereto. In some cases, this could allow the employee to interact with the system through the existing point-of-sale solution used in the original system, thereby eliminating the need for a new interface that would require employee training.

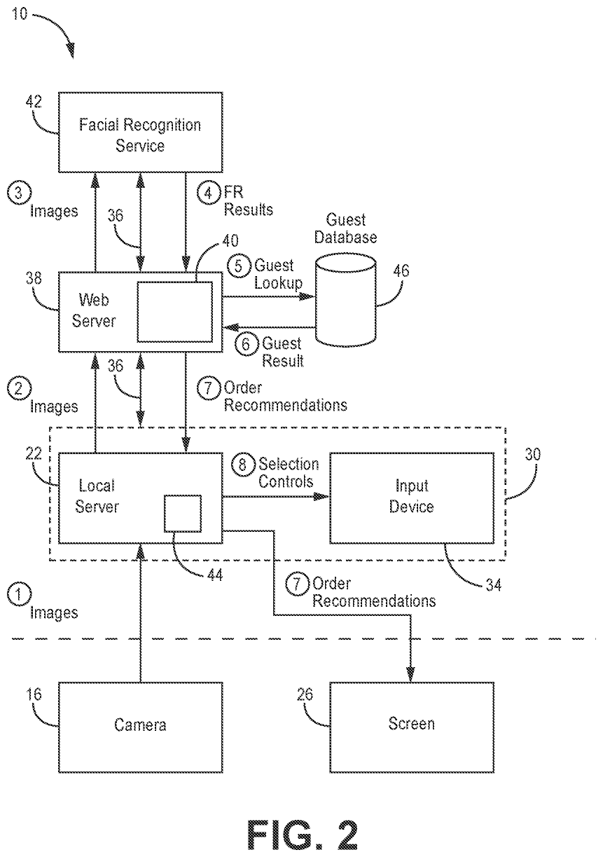

FIG. 2 provides a schematic depiction of the system 10 of FIG. 1, according to one embodiment, in which the additional off-site components are shown. As shown in the figure, and as discussed above, the system 10 has a local processor (or server) 22 that is electronically coupled to the camera(s) 16, 18, 20 and the screen 26 at the kiosk 12 and the interface 34 at the central console 30 accessed by the employee 32. Further, the local processor 22 is coupled via the Internet 36 to an external server 38. In certain embodiments, the external server 38 can be an off-site server 38 that can be located at any location in the world. According to certain system embodiments, the server 38 has a module 40 having known facial recognition software thereon (or is coupled thereto) or is coupled via the Internet 36 to a known facial recognition service 42. For example, the facial recognition system that can be provided as software in module 40 or the service 42 can be commercially available systems such as Amazon Rekognition™, which is available from Amazon, or Megvii Face++™, which is available from Megvii. In one embodiment, software is provided in a module 44 at the local processor 22 (or coupled thereto) that uploads or otherwise transmits images captured from the kiosk camera(s) 16, 18, 20 to the external server 38. Further, the image captured from the camera(s) 16, 18, 20 can be compared to a stored image of the customer that is stored in the customer information database 46 and coupled to the server 38 as described below and thereby used to identify the customer via the facial recognition software/service. In one embodiment, the local processor 22 as described above can operate in the following fashion. The local processor 22 contains a module 44 having software and/or an algorithm that reviews a series of images captured by one of the cameras 16, 18, 20 and selects the image with the highest likelihood of a face. Once the image is selected, the processor 22 then compresses that image before transmitting the image to the external server 38, which uploads the image to the known facial recognition service 42 (or utilizes its own facial recognition software 40) for purposes of the facial recognition process. According to certain implementations, the operation of this local processor 22 as described with the image selection and compression steps can shorten the processing time, as well as enhance detection accuracy.

It is understood that the local processor 22 and the external processor 38 can each be any known type of processor for use in this type of system. More specifically, the local processor 22 can be any known local processor, including a standard computer for on a network of this type for use in a retail setting. Similarly, the external processor 38 can be any known processor for use as an off-site or central processor. It is understood that the external processor 38 is expected to be a larger processor (in size, speed, and memory) as would typically be used on a network for this type for use in a retail setting.

It is understood that both the module 40 in the external server 38 and the module 44 in the local processor 22 as depicted in FIG. 2 are intended to represent any software associated with each of those servers/processors 38, 22. That is, any software and/or algorithm disclosed or contemplated herein that interacts with the local processor 22 is represented by the module 44. It is understood that any such software and/or algorithm can be integrated as a module 44 into the server 22 (in a separate module or a single module containing all software) or in a separate component that is coupled to the server 22 such that the server 22 can access and interact with the software and/or algorithm as described herein such that the software and/or algorithm can perform its intended function. Similarly, any software and/or algorithm disclosed or contemplated herein that interacts with the external server 38 is represented by the module 40. It is understood that any such software and/or algorithm can be integrated as a module 40 into the server 38 (in a separate module or a single module containing all software) or in a separate component that is coupled to the server 38 such that the server 38 can access and interact with the software and/or algorithm as described herein such that the software and/or algorithm can perform its intended function.

Alternatively, the local processor 22 can also contain or be coupled to a software module 44 and/or algorithm that reviews a series of images captured by the car lane camera 20 and selects the image with the highest likelihood of an accurate depiction of the cars positioned in the car lane. Once the image is selected, the module/algorithm 44 then identifies the different cars in the image and totals the number of cars in the image, thereby “counting” the number of cars in the lane. Once the number of cars has been identified, that information is transmitted by the processor 22 to the external server 38 and/or the interface 34. If received at the interface 34, the information can be provided to and/or accessed by the employee 32 using the interface 34. As such, the employee 32 can use this information to anticipate the impending number of orders at the kiosk 12 and plan accordingly. Alternatively, if received (or also received) at the external server 38, the information about the number of cars can be processed by the server 38 to determine the menu items displayed at the display 26 of the kiosk 12. That is, if there are a large number of cars in the line, the server 38 can trigger the display 26 to show menu items that can be prepared more quickly than other items on the menu, thereby potentially speeding up the ordering and order completion process and reducing the number of customers waiting in line. Alternatively, if there are a small number of cars or no cars in line, then the server 38 can trigger the display 26 to show the menu items tailored to the customer's preferences or any other set of menu items as discussed elsewhere herein.

In a further alternative, the local processor 22 can also contain or be coupled to a unique software module 44 and/or algorithm that reviews a series of images captured by the license plate camera 18 and selects the image with the highest likelihood of depicting a license plate 50 of the target car 48. Once the image is selected, the module/algorithm 44 then transmits the image of the license plate to the external server 38, which can upload the image to a known object identification service (or utilizes its own object identification software module 40) for purposes of the license recognition process, which can be used to uniquely identify the customer 28 driving the car 48 having that license plate 50. More specifically, the object identification process can proceed in a fashion similar to the facial recognition process as described elsewhere herein, such that the license plate number can be matched to a stored license plate number of a customer in the customer information database 46, thereby identifying the customer. It is understood that the license plate camera 18 can be used in place of, or in conjunction with, the user image camera 16 to help identify the customer. More specifically, in certain implementations, the license plate camera 18 can be used to identify the customer as described herein instead of the user image camera 16 (such that the user image camera 16 need not be provided in certain system embodiments). Alternatively, in other embodiments, the license plate camera 18 can be used as a “back-up” or a supplement to the user image camera 16 such that both cameras 16, 18 can be used to help identify the customer or either can be used if the other is not operable for any reason.

The customer information database 46 of the system 10 is operably coupled to the external server 38 such that the customer information is accessible by the external server 38. The customer information database 46 can be used to store information about each customer, including an appropriate customer image (that can be used for the facial recognition process as described in further detail below), past orders, and any other customer information that can be stored in a database. In certain implementations, the external server 38 can also have a known machine learning system in the form of software in a module 40 accessible to the server 38 or in any other known form that can be accessed by the server 38 to utilize known machine learning capabilities. According to one embodiment, the known machine learning system is provided with customer order information and is designed to learn customer preferences and predict future preferences by identifying patterns in that customer information. As just one specific example, customers that order a hot dog might historically also typically order coffee.

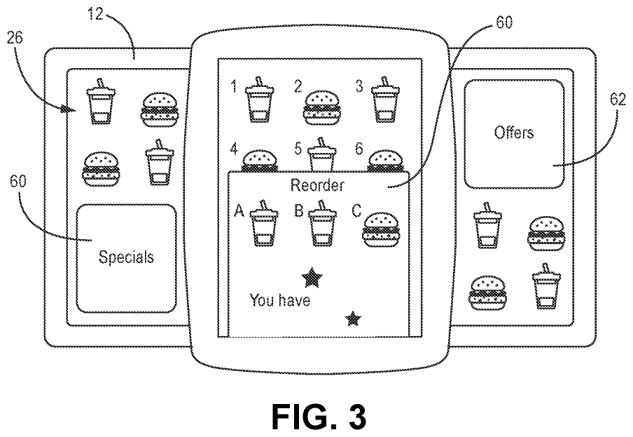

In use, when a customer 28 pulls up to the drive-through kiosk 12 and the camera 16 captures the customer's face (as schematically depicted in FIG. 1 according to one embodiment), the image is transmitted to the local processor 22, which transmits the image to the external server 38, where the facial recognition software module 40 or service 42 performs the facial recognition on the image via a known process. Typically, the facial recognition software module 40 or service 42 accesses the images of all known customers in a customer information database 46 to determine if the customer 28 matches one of those stored customer images. If the facial recognition process results in identification of the face as that of a known customer, the external server 38 is automatically triggered to access the customer's information in the customer information database 46 coupled to the server 38 and transmit certain parts of the customer information to the local processor 22. For example, the system 10 could trigger the external server 38 to transmit the customer's past order history, or some portion thereof (perhaps only the last 5 orders, for example). Alternatively, the system 10 could trigger the external server 38 to transmit some portion of the customer's past order history and certain offers or order recommendations or other incentive-based information based on the customer's stored information. The local processor 22 would transmit this information to the screen 26 on the kiosk 12 in an appropriate format for display such that it is visible to the customer 28, as also shown according to one in FIG. 3.

Turning now to FIG. 3, which depicts one specific exemplary embodiment of a digital screen 26 on a kiosk 12, the server 22 can send information to the screen 26 such that the screen 26 depicts predetermined menu items, as discussed elsewhere herein. For example, in one implementation, the screen 26 can show special menu items 60 that can be tailored to the customer. Further, the screen 26 can also show specific offers 62 for the customer that may be tailored to the customer or may be provided by the system to speed up the ordering and fulfillment process. In addition, the screen 26 can also show past orders 64 that the customer likes and can easily reorder. Each of these specific menu item displays are described elsewhere herein and can be provided by any system embodiment disclosed or contemplated herein.

It is understood that the digital screen 26 as depicted in FIG. 3 and the specific configuration thereof is simply one specific, exemplary configuration. The screen 26 can have any other known configuration and/or arrangement of the features on the screen 26. Further, it is understood that any screen embodiment contemplated herein can have any one or more of the specific menu items displayed in FIG. 3, including the special menu items 60, the specific offers 62, and/or the past orders 64, and any combination thereof, but need not have all of them.

Based on the information displayed for the customer 28 at the kiosk screen 26, the customer 28 can react to this information in the process of placing her order. For example, the system 10 can allow for the customer 28 to view the information, such as, for example, past order history (such as the past orders 64 depicted in FIG. 3), and re-order something from that history by verbally instructing the employee 32 to make that selection via the intercom system. The system interface 34 would allow for the employee 32 to select the previous item on the interface 34, which would add the item to the current order for the customer 28. Further, other information could be provided to the customer 28 via the display 26 that can be tailored to that specific customer 28, as described above with respect to FIG. 3 and as will be described in additional detail below.

For example, in one specific embodiment, the past order history (such as the past orders 64 as shown in FIG. 3) can be displayed by the system 10 on the customer kiosk screen 26 and the employee interface screen 34. The items, according to certain implementations, can be numbered (1, 2, 3, etc.) and the customer 28 can tell the employee 32 that she would like to “reorder number 2,” for example. The employee 32 can then select this item in the interface 34 and add it to the guest's order. In certain implementations, the re-ordered item can be automatically customized with the add-ons (bacon, extra mustard, etc.), exclusions, or other specific adjustments to any standard menu item that the customer 28 included in her previous order. This automatic customization can speed the ordering process.

In those embodiments in which the system 10 has a car lane camera 20, the server 22 can also provide order recommendations or incentives based on the number of cars detected in the car lane, as described above. These recommendations, incentives, or other offers or information created by the server 22 can be displayed for the customer 28 on the screen 26 at the kiosk 12 such that the customer 28 has an opportunity to select any of those offers and order that selection in the same fashion as described above for the re-order selection. As mentioned above, the server 22 would provide a list of recommended items or incentives that would be directed to menu items that can be prepared and provided to the customer quickly, thereby potentially reducing the line of cars.

As a result, the server 22 can recommend items on the screen 26 (and again, on the employee input device 34 for selection) that the server 22 has identified as items that can be prepared quickly. For example, if the system 10 knows that a specific burger or sandwich can be prepared quickly, it would be listed as a recommended menu item on the screen 26.

Further, in certain embodiments, the system 10 can detect a new customer. That is, because the system 10 can identify an existing customer that is already stored in the database 46 of the system 10, it can also identify a first-time customer that is not in the system 10 through similar steps of the facial recognition process as discussed above. That is, when a new customer pulls up to the drive-through kiosk 12 and the camera 16 captures the customer's face (as schematically depicted in FIG. 1 according to one embodiment), the image is transmitted to the local processor 22, which transmits the image to the external server 38, where the facial recognition software module 40 or service 42 performs the facial recognition on the image via a known process. That is, the facial recognition software module 40 or service 42 typically accesses the images of all known customers in the customer information database 46 to determine if the customer matches one of those stored customer images. Because the customer is a new customer, the facial recognition process will not result in a match with any image of any known customer, which will automatically trigger the external server 38 to transmit that information to the local processor 22.

Once the customer 28 has been identified as a first-time customer, the system 10 can be automatically triggered to provide that information to the employee 32 and, according to certain optional implementations, can provide a suggestion that the employee 32 offer a free token item to the customer 28, such as a free coffee or other such item. Further, in certain embodiments, the system 10 can also be automatically triggered to store an image of the first-time customer in the customer database 46 as depicted in FIG. 2. More specifically, the local server 22 transmits the image to the web server 38, which stores the image in the customer database 46. Subsequently, when the customer 28 returns, the system 10 can identify the customer 28 according to the process described above for any existing customer.

In those implementations in which a machine learning system module 40 is provided, the server 22 can also provide order recommendations or incentives based on the patterns identified and/or predictions generated by the machine learning system module 40. These recommendations, incentives, or other offers or information created by the machine learning system module 40 can be displayed for the customer 28 on the screen 26 at the kiosk 12 such that the customer 28 has an opportunity to select any of those offers and order that selection in the same fashion as described above for the re-order selection. For example, the specials 60 and offers 62 depicted in FIG. 3 and discussed above can be generated by the machine learning system module 40, according to one embodiment.

For example, in one specific implementation in which the system 10 has a machine learning system module 40, the system 10 can recommend items on the screen 26 (and again, on the employee input device 30 for selection) that the machine learning system module 40 has calculated that the customer 28 is likely to order. For example, if the module 40 knows that the customer 28 regularly orders coffee based on past orders, the module 40 might suggest a special coffee drink that's new on the menu. The system 10 can use a number of other signals in the machine learning process to determine what to offer a guest. For example, one input could be weather—if it is a particularly hot day, the recommended item could be iced versions of other beverages they have, such as iced teas and iced coffees.

In certain embodiments, the system 10 can collect additional information about the customer beyond just order history and other basic information that can be stored in the customer information database 46. For example, according to some implementations, the system 10 can collect information relating to age, gender, ethnicity, or any other relevant information. Such information can be provided to a marketing database (not shown) that can be accessed by certain marketing people within the company and thereby be used for various marketing activities or campaigns.

In further implementations, the system 10 can utilize certain known facial recognition technology (such as the software module 40 or service 42 discussed above) to detect the mood of the customer. The system 10 can use this information to gauge various parts of the customer's interaction. For example, the system 10 can use the information to gauge whether and how the customer's mood changes over the course of the interaction or to gauge general customer satisfaction. Alternatively, the system can use the information to gauge employee performance.

In accordance with certain other embodiments, the customer information can include the customer's membership in a company loyalty program, such that the loyalty program membership information is linked to the rest of the customer information. Thus, the next visit (and every future visit) by the customer 28, the system 10 is automatically triggered to associate or link any purchases with that customer's loyalty membership without requiring the customer 28 to produce any proof the membership.

In certain implementations, it is understood that the customer information is stored on the centrally located database 46 in the system 10 as discussed above that can be accessed by any store location of the company. As such, the system 10 will recognize the customer 28 at any kiosk 12 at any store location that the customer visits anywhere in the United States (and potentially anywhere in the world) and provide the same automatic information at such location. According to other embodiments, the customer information can also be collected during interactions inside the store (not just at an kiosk) and saved into the customer's information on the database 46 such that it can be accessed by and used by the system 10 for future interactions with the customer 28 at the drive-through kiosk or at any other interface.

Based on the various features described herein, it is understood that certain advantages of this system 10 over a standard, known drive-through include, but are not limited to, better, tailored service, faster service, and generally better service for all customers based on the aggregate service and marketing information collected from all the customers.

While the system embodiments disclosed here are generally discussed in the context of drive-through kiosks, it is understood that these embodiments can be used in any number of contexts, including any system having commercial kiosks or other interfaces in any type of commercial setting, including malls, movie theaters, etc. There is no requirement that the systems be limited to use with drive-through kiosks.

Although the present invention has been described with reference to preferred embodiments, persons skilled in the art will recognize that changes may be made in form and detail without departing from the spirit and scope of the invention.

What is claimed is:

1. A network-based retail order satisfaction system, the system comprising:
(a) a local processor on a network, the local processor accessible by an employee user;
(b) a local kiosk, the kiosk comprising:
(i) at least one camera disposed on or near the kiosk, wherein the at least one camera is operably coupled to the network;
(ii) a digital display disposed on the kiosk, wherein the digital display is operably coupled to the network;
(iii) a speaker disposed on the kiosk; and
(iv) a microphone disposed on the kiosk;
(c) a central processor in communication with the local processor via the network;
(d) a customer information database in communication with the central processor, the customer information database configured to store customer information and existing customer images; and
(e) facial recognition software associated with the central processor, the facial recognition software configured to compare an image of an individual captured by the at least one camera with the existing customer images.

2. The order satisfaction system of claim 1, further comprising machine learning software associated with the central processor, the machine learning software configured to learn customer preferences and predict future customer preferences based on historical customer order information.

3. The order satisfaction system of claim 2, wherein the machine learning software is further configured to select menu items to display on the digital display based on the customer preferences.

4. The order satisfaction system of claim 1, further comprising additional local kiosks, wherein each of the additional local kiosks is disposed at a different location.

5. The order satisfaction system of claim 4, wherein the central processor is disposed at a remote location in relation to the local kiosk and the additional local kiosks.

6. The order satisfaction system of claim 1, wherein the at least one camera comprises:
(a) a first camera disposed to capture the image of the individual; and
(b) a second camera disposed to capture an image of a car lane adjacent to the kiosk.

7. The order satisfaction system of claim 6, wherein
the facial recognition software is configured to compare the image of the individual captured by the first camera with the existing customer images, and
object recognition software is configured to analyze the image of the car lane and determine a number of cars disposed in the car lane.

8. The order satisfaction system of claim 1, wherein the at least one camera comprises:
(a) a first camera disposed to capture the image of the individual; and
(b) a third camera disposed to capture an image of a license plate on a car adjacent to the kiosk.

9. The order satisfaction system of claim 8, wherein
the facial recognition software is configured to compare the image of the individual captured by the first camera with the existing customer images, and
object recognition software is configured to analyze the image of the license plate captured by the third camera and compare a number on the license plate with the customer information.

10. The order satisfaction system of claim 1, wherein the system can be incorporated into an existing point-of-sale system and the local processor is coupled to an existing point-of-sale interface.

11. A network-based retail order satisfaction system, the system comprising:
(a) a local processor on a network, the local processor accessible by an employee user;
(b) a plurality of local kiosks, each of the plurality of local kiosks comprising:
(i) a user image camera disposed on or near the kiosk to capture an image of an individual, wherein the user image camera is operably coupled to the network;
(ii) a digital display disposed on the kiosk, wherein the digital display is operably coupled to the network;
(iii) a car lane camera disposed on or near the kiosk to capture an image of a car lane adjacent to the kiosk, wherein the car lane camera is operably coupled to the network;
(iv) a license plate camera disposed on or near the kiosk to capture an image of a license plate on a car adjacent to the kiosk, wherein the license plate camera is operably coupled to the network;
(v) a speaker disposed on the kiosk; and
(vi) a microphone disposed on the kiosk;
(c) a central processor in communication with the local processor via the network;
(d) a customer information database in communication with the central processor, the customer information database configured to store customer information existing customer images;
(e) facial recognition software associated with the central processor, the facial recognition software configured to compare the image of the individual captured by the user image camera with the existing customer images;
(f) machine learning software associated with the central processor, the machine learning software configured to learn customer preferences and predict future customer preferences based on historical customer order information; and
(g) object recognition software configured to:
(i) analyze the image of the car lane and determine a number of cars disposed in the car lane; and
(ii) analyze the image of the license plate captured by the third camera and compare a number on the license plate with the customer information.

12. The order satisfaction system of claim 11, wherein the central processor is disposed at a different location in relation to the plurality of local kiosks.

13. The order satisfaction system of claim 11, wherein the system can be incorporated into existing point-of-sale systems at a plurality of retail locations.

14. The order satisfaction system of claim 13, wherein the local processer is coupled to an existing point-of-sale interface.

15. A method of receiving and fulfilling a retail order, the method comprising:
providing a local kiosk at a retail location, the kiosk comprising:
(a) at least one camera disposed on or near the kiosk;
(b) a digital display disposed on the kiosk;
(c) a speaker disposed on the kiosk; and
(d) a microphone disposed on the kiosk;
capturing an image of a customer with the at least one camera;
identifying the customer based on the image of the customer;
using stored customer information about the customer to predict future customer preferences; and
providing menu items for selection by a customer on the digital display based on the predicted future customer preferences.

16. The method of claim 15, wherein the identifying the customer based on the image of the customer further comprises comparing the image of the customer with existing customer images from a customer information database.

17. The method of claim 15, wherein the kiosk further comprises:
(a) a first camera disposed to capture the image of the individual; and
(b) a second camera disposed to capture an image of a car lane adjacent to the kiosk.

18. The method of claim 17, further comprising:
capturing the image of the customer with the first camera;
capturing the image of the car lane with the second camera; and
determining a number of cars disposed in the car lane based on the image of the car lane.

19. The method of claim 15, wherein the kiosk further comprises:
(a) a first camera disposed to capture an image of a license plate on a car adjacent to the kiosk; and
(b) a second camera disposed to capture an image of a car lane adjacent to the kiosk.

20. The method of claim 19, further comprising:
capturing the image of the license plate with the first camera;
identifying the customer based on the image of the license plate;
capturing the image of the car lane with the second camera; and
determining a number of cars disposed in the car lane based on the image of the car lane.
